(19) United States
(12) Patent Application Publication
(10) Pub. No.: US 2025/0247408 A1
(43) Pub. Date: Jul. 31, 2025

(54) SYSTEMS AND METHODS FOR THREAT RISK MANAGEMENT

(71) Applicant: SAUDI ARABIAN OIL COMPANY, Dhahran (SA)

(72) Inventor: Mariam Fahad BUBSHAIT, Dhahran (SA)

(73) Assignee: SAUDI ARABIAN OIL COMPANY, Dhahran (SA)

(21) Appl. No.: 18/429,078

(22) Filed: Jan. 31, 2024

(51) Int. Cl. H04L 9/40; H04L 9/32

(52) U.S. Cl. CPC H04L 63/1425; H04L 9/32

(57) ABSTRACT

Systems and methods are disclosed relating to cybersecurity. In an example, data encrypted according to a cryptographic key assigned to a user device requesting to use one or more system resources can be received. An authenticity of the cryptographic key can be verified for the user device. A level of security risk posed by the request from the user device to an organization can be determined (e.g., using a machine learning model), and a risk score indicative of the level of security risk posed by the request to the organization can be outputted. The user device is granted access to use the one or more system resources in response to the determining that the risk score is less than or equal to the risk score threshold, or denied to use one or more system resources in response to determining that the risk score is greater than the risk score threshold.

### FIELD OF THE DISCLOSURE

This disclosure relates generally to cybersecurity, and more specifically, to systems and methods for reducing cybersecurity threats.

### BACKGROUND OF THE DISCLOSURE

A cyberattack is any offensive maneuver that targets a computer information system, computer networks, infrastructures, personal computer devices, or smartphones. An attacker is a person or process that attempts to access data, functions, or other restricted areas of the system without authorization, potentially with malicious intent. A cyberattack can be employed by sovereign states, individuals, groups, societies or organizations and it may originate from an anonymous source. A cyberattack may steal, alter, or destroy a specified target by hacking into a private network or otherwise susceptible system. Cyberattacks can range from installing spyware on a personal computer to attempting to destroy the infrastructure of entire nations. One common cyberattack is the use of malware. Malware is any software designed to cause disruption to a computer, a server, a client, or computer network, leak private information, gain unauthorized access to information or systems, deprive access to information, or which unknowingly interferes with the user's computer and/or privacy.

In computer security, a threat is a potential negative action or event facilitated by a vulnerability that results in an unwanted impact to a computer system or application. A threat can be either a negative “intentional” event (e.g., hacking: an individual cracker or a criminal organization) or an “accidental” negative event (e.g. the possibility of a computer malfunctioning) or otherwise a circumstance, capability, action, or event. This is differentiated from a threat actor who is an individual or group that can perform the threat action (e.g., a malware attack), such as exploiting a vulnerability to actualize a negative impact. Thus, an attack (a cybersecurity attack), is the actual act of exploiting the information security system's weaknesses.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a computer-implemented method can include receiving data encrypted according to a cryptographic key assigned to a user device requesting to use one or more system resources, verifying an authenticity of the cryptographic key for the user device corresponding to confirming an identity of the user device or a user of the user device, determining a level of security risk posed by the request from the user device to an organization in response to verifying the cryptographic key is authentic, outputting a risk score indicative of the level of security risk posed by the request to the organization, determining whether the risk score is less than or equal to a risk score threshold, and one of granting the user device access to use the one or more system resources in response to the determining that the risk score is less than or equal to the risk score threshold, and denying the user device the request to use one or more system resources in response to determining that the risk score is greater than the risk score threshold.

According to another embodiment, a system can include a user device that can include a cryptographic key assigned for the user device. The user device can be configured to encrypt data according to the cryptographic key, the data comprising a request to use one or more system resources. The system can include a server configured to verify an authenticity of the cryptographic key for the user device corresponding to confirming an identity of the user device or a user of the user device, output, using a machine learning (ML) model, a risk score indicative of a level of security risk posed by a request from the user device to an organization in response to verifying the cryptographic key is authentic, determining whether the risk score is less than or equal to a risk score threshold, and one of causing the user device to be granted access to use the one or more system resources in response to the determining that the risk score is less than or equal to the risk score threshold, and causing the user device to deny the request to use one or more system resources in response to determining that the risk score is greater than the risk score threshold.

In a further embodiment, a system can include one or more computing platforms configured to receive data encrypted according to a cryptographic key assigned to a user device requesting to use one or more system resources, verify an authenticity of the cryptographic key for the user device corresponding to confirming an identity of the user device or a user of the user device, determine a level of security risk posed by the request from the user device to an organization in response to verifying the cryptographic key is authentic, output a risk score indicative of the level of security risk posed by the request to the organization, determine whether the risk score is less than or equal to a risk score threshold, and one of grant the user device access to use the one or more system resources in response to the determining that the risk score is less than or equal to the risk score threshold, and deny the user device the request to use one or more system resources in response to determining that the risk score is greater than the risk score threshold.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a system with a network on which a user risk analyzer is employed for reducing risk of insider threats to an organization (or the system).

FIG. 2 is an example of a cryptographic insider threat risk management system.

FIG. 3 is an example of the risk assessment module.

FIG. 4 is an example of the response module.

FIG. 5 is an example of a method for requesting use of one or more system resources.

FIG. 6 depicts an example computing environment that can be used to perform methods according to an aspect of the present disclosure.

FIG. 7 depicts a cloud computing environment that can be used to perform one or more actions according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure relate to reducing cybersecurity risks or threats to a system. Insider threats are a significant risk to an organization's security, as such threats (e.g., malware attacks that originate internally) can potentially compromise a security of an organization from within. For example, an insider threat can occur when an employee, contractor, or other trusted individual intentionally or unintentionally exposes a system (e.g., a computer, a computer network, etc.) to harm through their access to sensitive data or systems. These threats can take many forms, including a theft or misuse of sensitive information, sabotage of systems, or the introduction of malware or other malicious code into the network. Existing security measures rely on or user authentication (e.g., through use of a password), access control (e.g., through use of roles, departments, or specific permissions), and monitoring to protect against insider threats (e.g., through tracking usage and activities on a network and/or system).

However, these measures are vulnerable to attack or bypass, particularly when an insider is involved. For example, suppose a secure data system of a company uses user authentication, role-based access control, and continuous monitoring. For example, an employee who works in an information technology (IT) department of the company and has an understanding of internal systems and computers of the company can exploit the company's security vulnerabilities. For example, if the employee has access to a server room and has administrative privileges on the network, the employee can use assigned credentials to log in during off-hours. In some examples, if the employee has knowledge of how an access control system works, the employee could grant his account higher-level permissions and thus be granted access to confidential or secret data/information. In further or additional examples, if the employee understands the monitoring schedule and patterns, the employee can access system and or data (that the employee is not permitted to access, for example) during a period of low monitoring activity, perhaps during a system update or maintenance window, to avoid raising alarms.

Systems and methods are disclosed herein that mitigate risks of insider threats in a cybersecurity environment, such as described herein, and others. According to the examples herein, a user device can issue a resource request requesting use of one or more system resources of a system. The resource request can be encrypted by the user device according to a unique cryptographic key (encryption key). A user of the user device can present system requests encrypted according to a unique cryptographic key assigned to a particular user of the user device. A user risk analyzer can receive the resource request and decrypt the resource request. If the decryption is successful, the resource request can be processed to determine whether the resource request should be granted or denied based on user permission and/or a level of risk associated with the resource request. Thus, to mitigate risk of insider threats, examples are presented herein that you use a two-level framework for granting a user device access to use system resources of a system. The two-level framework includes a first level in which a unique cryptographic key is used to verify that the resource request is authentic (and thus the user device issuing it is authentic), and a second level through analysis of user permission and/or the level of risk posed by the resource request.

Accordingly, the one or more examples disclosed herein provides a comprehensive and secure system for managing and mitigating the risk of insider threats in a cybersecurity environment through the use of cryptographic and machine learning technology. By using unique cryptographic keys and a central server, in some examples, to verify the identity and permissions of users, and by continuously monitoring the network for unusual or suspicious activity and taking appropriate action in response, organizations can significantly reduce insider threat risks and protect against the potential harm such threats can cause.

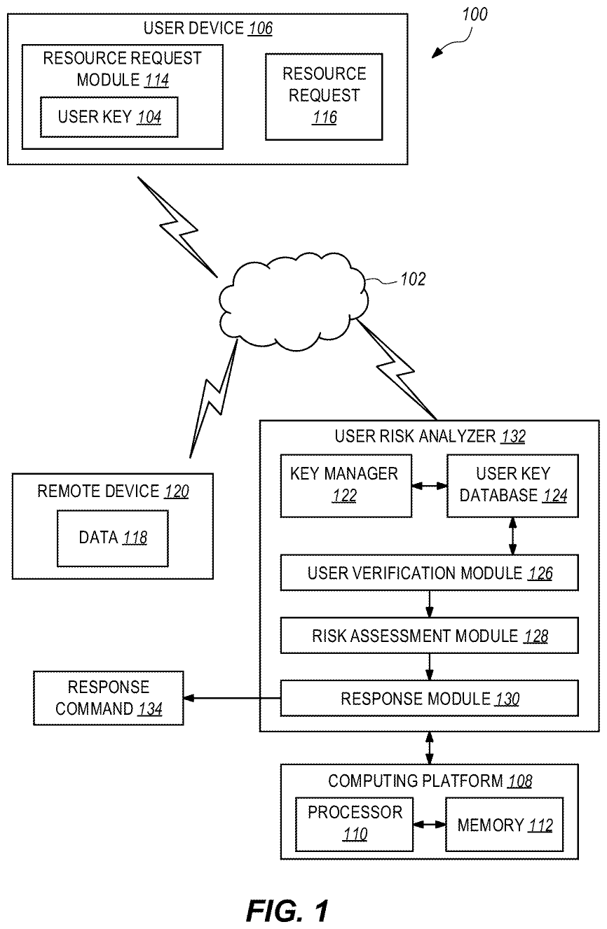

FIG. 1 is an example of a system 100 with a (computer) network 102 on which a user risk analyzer 132 is employed for reducing a risk of insider threats (e.g., an employee, for example). A user device 106 can be coupled to the network and a computing platform 108, on which the user risk analyzer 132 can be implemented. In some examples, the network 102 is a local area network (LAN) and the user device 106 and the computing platform 108 can communicate using the network 102. In other examples, the network 102 is a wide area network (WAN). In some examples, the network 102 includes corporate or enterprise networks (e.g., which can include one or more LANs, WAN connections, security systems, data centers, cloud infrastructures, etc.). The network 102, in some examples, can be a data center network, a cloud network, a peer-to-peer (P2P) network, or an internet of things (IoT) network.

The user risk analyzer 132 can be implemented using one or more modules, shown in block form in the drawings in the example of FIG. 1. The one or more modules can be in software or hardware form, or a combination thereof. In some examples, the user risk analyzer 132 can be implemented as machine-readable instructions for execution on the computing platform 108, as shown in FIG. 1. The computing platform 108 can include any computing device, for example, a desktop computer, a server, a controller, a blade, a mobile phone, a tablet, a laptop, a personal digital assistant (PDA), or other types of portable (or stationary) devices. The computing platform 108 can include a processor 110 and a memory 112. By way of example, the memory 112 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 110 can be implemented, for example, as one or more processor cores. The memory 112 can store machine-readable instructions (e.g., the user risk analyzer 132) that can be retrieved and executed by the processor 110. Each of the processor 110 and the memory 112 can be implemented on a similar or a different computing platform.

The user device 106 can correspond to any device that one or more users can use to utilize system resources. The example of FIG. 1 illustrates a single user device but in other examples any number of user devices similar to the user device 106 can be used for system access. The term “system resource utilization” or its derivatives as used herein can include data access or retrieval, data manipulation, communication (e.g., sending emails or messages, etc.), transaction processing (e.g., conducting a financial transaction, etc.), control and command execution (e.g., operating remote devices or machinery (e.g., in an IoT setup), executing software commands or running programs, adjusting settings or configurations in applications or devices, etc.), data analysis (e.g., data analytics or reporting tools, etc.), collaboration and project management (e.g., using collaboration tools for projects, task or project retrieval, etc.), for example. Thus, system utilization can include a number of software activities, from accessing and viewing data to actively manipulating data, analyzing, or creating data, as well as controlling devices or executing specific tasks on devices.

The user device 106 includes a resource request module 114 that can receive a resource request 116 requesting use of one or more system resources. In the examples herein, the resource request 116 can be a data access request and thus requesting use (access) of data on the system 100, but in other examples, the resource request 116 can be a different type of request (e.g., activate a program, or function). The resource request module 114 can be used to communicate with the user risk analyzer 132 to determine whether the resource request 116 should be granted or denied according to one or more examples disclosed herein. The resource request module 114 can be implemented as machine-readable instructions and stored in memory of the user device 106, which can be memory similar to the memory 112. The user device 106 can include a processor to access the memory and execute the machine-readable instructions corresponding to the resource request module 114 to control access to system resources by the user device 106. In some examples, the processor of the user device 106 can be implemented similarly to the processor 110, as shown in FIG. 1. In some examples, the resource request 116 can be generated by an application (or program) executing on the user device 106. In one example, the resource request 116 is a request to access data 118, which can be stored on a remote device 120. The remote device 120 can correspond to any device that stores the data 118 and allows for access to the data 118 (e.g., for reading and/or manipulation) using the network 102. In some examples, the data 118 can be stored in the memory 112 of the computing platform 108.

The resource request module 114 can receive the resource request 116. The resource request module 114 can receive a cryptographic key (referred to herein as a “user key”) for the user device 106 (or the user of the user device 106). For example, the resource request module 114 can generate a user key request graphical user interface (GUI) that can be rendered on a display of the user device 106 (e.g., as disclosed herein). The user can use the GUI to provide the cryptographic key that the user or the user device 106 has been assigned, which can then be used for encrypting data for verifying an authenticity of the user key 104. In other examples, the user key can be provided through a different mechanism (e.g., loaded onto the user device 106 through a USB device).

In some examples, the resource request module 114 can communicate with the user risk analyzer 132 for the user key. For example, upon initialization on the user device 106, the resource request module 114 can issue a key request for its user key, which can be provided to the user risk analyzer 132. In some examples, a secure communication channel can be established between the user device 106 and the computing platform 108. This secure communication channel can be established using a temporary initial key or a standard protocol, for example, Transport Layer Security (TLS). Once a secure channel is established, the user key can be provided from the computing platform 108 to the user device 106. The resource request module 114 can generate the GUI with the user key for the user. After a period of time, the user key can be stored locally on the user device 106 (e.g., in the memory) and a root directory or location to where the user key has been stored on the user device 106 can be provided to the user for later use. Only the user knows the location of the user key (or where it is stored on the user device 106), which provides a layer of security that mitigates insider threats. The user of the user device 106 can locate the user key and input into the user key request GUI requesting the user key. The user key request GUI can be generated before or after the resource request module 114 receives the resource request 116.

The user risk analyzer 132 includes a key manager 122 to process the key request so that the user key can be provided to the user device 106. The key manager 122 can generate and distribute cryptographic keys for user devices, such as the user device 106. The key manager 122 can use or employ a cryptographic algorithm to generate a unique user key for each user device 106 (or user). The user key can be a symmetric key (same key for encryption and decryption), or an asymmetric key pair (a public key and a private key). For symmetric key generation, the key manager 122 can use a secure random number generator to create the user key. For asymmetric keys, the key manager 122 can generate a key pair using algorithms like RSA (Rivest-Shamir-Adleman) or ECC (Elliptic Curve Cryptography). The private key is kept secret, while the public key can be shared with the user device 106. Each user device can have its own public key (user key). In some examples, the user risk analyzer 132 provides the user key to another device associated with the user, which can be configured to execute a resource request module so that the user can retrieve the user key (and use the user key at the user device 106). Thus, the user can be allowed access, in some examples, to a network device based on a symmetric key encryption, where functions are enabled based on this key.

For example, the key manager 122 can receive the key request, and search or query a user key database 124. The user key database 124 can store a cryptographic user key for each user device 106 and provide this user key to the user device 106. The user key database 124 can associate (e.g., logically link) an identifier for the user device 106 (or the user) with the cryptographic user key. The identifier can be used to locate the cryptographic user key in the user key database 124 for the user device 106 (or the user). For example, the identifier can be a device identifier (ID), internet protocol (IP) address, or any other identifier that uniquely identifies the user device 106 (or the user). The key manager 122 can provide the user key from the key database 124 to the user device 106 based on the key request.

The user device 106 can provide encrypted data using the user key 104 (the cryptographic key) to the user risk analyzer 132, which can validate its authenticity corresponding to confirming an identity of the user device 106. The data that is encrypted by the user device 106 can be the resource request 116, in some examples. The user risk analyzer 132 can include a user verification module 126 for verifying the identity of the user device 106 based on its assigned cryptographic key. The user key can be used to verify whether the resource request 116 and/or the user device 106 that issued the resource request 116 is authentic. For example, suppose the user wants to access the data 118 on the remote device 120. The user device 106 initiates the resource request 116. If a symmetric key system is used, the resource request module 114 of the user device 106 can encrypt a piece of known data or a timestamp with its symmetric key and send it to the user risk analyzer 132. In some examples, the piece of known data is the resource request 116. Thus, the resource request module 114 can employ an encryption algorithm to encrypt the piece of known data (e.g., the resource request 116). The user verification module 126 decrypts this data with a corresponding symmetric key it holds. If the decryption is successful, the identity of the user device 106 (or the user) is verified. In an asymmetric system, the resource request module 114 of the user device 106 can sign the resource request 116 with its private key. The user verification module 126 can then use a stored public key (unique for that user device 106), for example, stored in the user key database 124, to verify the signature. If the signature is valid, the user verification module 126 confirms the identity of the user device 106 (or the user). In some examples, a decryption of the data is successful and the data is as expected, for example, if contains correct timestamps, identifiers (e.g., user identifier (IDs), or device IDs), or other information that is known.

If the user verification module 126 verifies that the user device 106 is authentic, a risk assessment module 128 of the user risk analyzer 132 can be used to determine whether to grant or deny the resource request 116 (e.g., whether the user device 106 can use the one or more system resources). The risk assessment module 128 can continuously monitor the network 102 for unusual or suspicious activity. The risk assessment module 128 can analyze various factors, including user activity, network traffic patterns, and system logs, to identify potential insider threats. If the risk assessment module 128 detects a potential threat, it activates a response module 130 of the user risk analyzer 132, which takes action to prevent or mitigate the threat. The risk assessment module 128 can determine whether the user device 106 (and thus the user) pose a threat based on the user's permissions and a level of risk associated with the request. The response module 130 can take a variety of actions, depending on the nature and severity of the threat. For example, the response module 130 can issue a response command 134 that can block access to the data 118 or the remote device 120 (or one or more systems), issue an alert to security personnel, or initiate a forensic investigation to determine the source of the threat.

Accordingly, the use of cryptographic technology in the system 100 offers several advantages over traditional security measures in the protection against insider threats. First, cryptographic keys are much more secure than traditional passwords, as such keys are typically much longer and more complex, thus are resistant to cracking or guessing attacks. This makes it much more difficult for an insider to gain unauthorized access to sensitive data or systems. Second, the user risk analyzer's verification of cryptographic keys allows for a more fine-grained control over access to sensitive data and systems. Permissions can be granted or revoked on a per-user, per-system, or per-data basis, providing a high level of flexibility and granularity in controlling access. Third, the continuous monitoring and risk assessment provided by the user risk analyzer 132 enables organizations to proactively identify and address potential insider threats before they can cause harm or they get compromised. By analyzing various factors, including user activity, network traffic patterns, and system logs, the risk assessment module 128 can detect unusual or suspicious activity that may indicate an insider threat. Fourth, the response module's ability to take a variety of actions in the event of a detected threat allows organizations to tailor their response to the specific nature and severity of the threat. This flexibility enables organizations to effectively address a wide range of potential insider threats, from minor incidents to major breaches. Fifth, the use of cryptographic technology in the present invention allows for the implementation of secure communication channels within the system, further protecting against the potential compromise of sensitive data or systems by insiders. Accordingly, the system 100 uses cryptography and AI related technology to reduce an associated risk posed from insider threats so these threats can be detected and/or prevented.

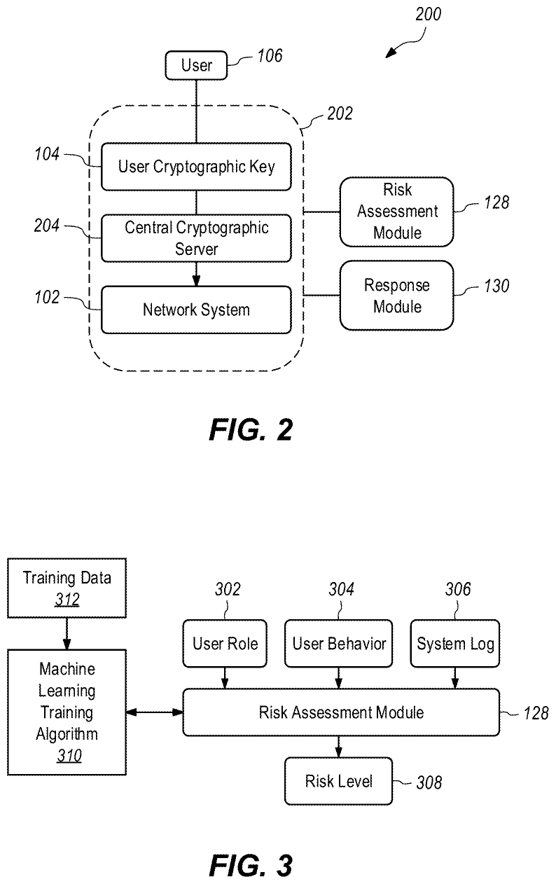

FIG. 2 is an example of a cryptographic insider threat risk management system 200. For example, the system 200 includes a cryptographic system 202 with a cryptographic server 204 that communicates with the network 102, as shown in FIG. 1. Thus, reference can be made to the example of FIG. 1 in the example of FIG. 2. The cryptographic server 204 can be configured to implement or correspond to the user verification module 126, as shown in FIG. 1. Thus, in some examples, the cryptographic server 204 can be configured to verify an authenticity of the user key 104 according to one or more examples as disclosed herein with respect to the user verification module 126. For example, the cryptographic server 204 can receive the resource request 116 having been encrypted according to user key 104. If the user key 104 for the user device 106 is verified as authentic, the cryptographic server 204 can communicate with the risk assessment module 128. The risk assessment module 128 can determine whether the resource request 116 should be granted or denied through use of risk levels. In some examples, the user key 104 for the user device 106 is determined to be not authentic, and the resource request 116 is denied (e.g., blocking access to the data 118, as shown in FIG. 1).

FIG. 3 is an example of the risk assessment module 128, as shown in FIGS. 1-2. Thus, reference can be made to one or more examples of FIGS. 1-2 in the example of FIG. 3. In some examples, the risk assessment module 128 is a trained machine learning model. In a non-limiting example, the machine learning model is a logistic regression model. Other machine learning models can be used as well as the risk assessment module 128. The risk assessment module 128 can continuously monitor the network 102 for unusual or suspicious activity and detect for a potential threat, and activates the response module 130 in response to detecting the threat, which takes action to prevent or mitigate the threat.

For example, the risk assessment module 128 can output (predict) a risk score (or level) 308 indicative of a level of (behavioral) risk posed by the resource request 116. In some examples, the risk score can be determined from 1 to 10, where 10 is a highest risk score and 1 is a lowest risk score. Thus, the risk score 308 can indicate a level of security risk posed by the resource request 116 (or the user device 106 that issued the resource request 116) to an organization (e.g., a business, a university, etc.). The risk assessment module 128 can output the risk score 308 based on a user role (information) 302, user behavior (information) 304, and system log information 306. The system log information 306 can include system logs and users logs from a security information and event management (SIEM) application or tool, and from system specific logs such as windows and/or server logs. The user behavior 304 can characterize, for example, how many access points has this specific user tried to enter (e.g., in some instances over a period of time), successful and denied access requests, time difference, and correlation with the user role, and in some instances other information. The time difference refers to time intervals at which a user accesses different points or resources within a system or network in correlation to an assigned role. An access point can include, but not limited to, a file server, a database, an application, a network node, etc. The time intervals can be analyzed to determine a user's activity pattern, which can be provided in some instances as part of the user behavior 304. For example, frequent or irregular access to sensitive resources might be unusual and could indicate suspicious behavior. In some examples, a user's role can be considered in relation to access patterns. In some examples, a user's role within the organization or system can be considered when analyzing these access patterns. Different roles can have different expected patterns of access. For instance, an IT administrator might regularly access multiple servers, while a salesperson might not. An analysis can be implemented (e.g., by a SIEM tool or other software (e.g., system logs system)) to determine if the user's behavior (as indicated by their access patterns) is consistent with the expectations and permissions of their role, which can be provided as part of the user behavior 304. Thus, the analysis can be used to determine if a user behavior is acceptable for an assigned role.

An access point can refer to an entry point or interface through which the user can interact with a system, network, or facility, for example, network access points (e.g., hardware device), system or application access points (e.g., software access, such as login portals, application program interfaces (APIs), or service endpoints), physical access points (e.g., doors, gates, or other entryways to a facility or secured area that is controlled by access control systems like card readers or biometric scanners), data access points (e.g., different data retrieval points or queries that the user can perform). The system log information 306 can characterize server name (e.g., of a server from the user is trying to use system resources), a server IP address, files name (e.g., of files the user has access in the past), a location, a system owner, an OS type (e.g., the OS of the user device 106), a source IP address, destination IP address, an application name (e.g., which the user is trying to access), an application ID, running services, and/or a time. The location can identify a location from which the user is connecting from (e.g., an office location, a home or abroad location (outside of the country)). The system owner can identify an entity that is an owner of the server based on a company's asset inventory. The source IP address can identify a workstation IP and the destination IP address can identify a server IP that the user is trying to access. The running services can include a web server (e.g., Apache) or a powershell script. The user role 302 can indicate a role of the user, for example, a database administrator, an infrastructure engineer, a developer, or a human resource (HR) analyst.

The risk assessment module 128 can be trained by machine learning training algorithm 310 using training data 312. The training data 312 can include previously captured user behaviors for a number of users, system log information and assigned user roles for the users. The previously captured user behaviors and the system log information can include similar data points as disclosed herein (e.g., as described with the respect to the user role 302, the user behavior 304, and the system log information 306. The machine learning training algorithm 310 can train a machine learning model based on the training data 312 to provide the risk assessment module 128. In some examples, the machine learning training algorithm 310 can be implemented on a computing platform, such as the computing platform 108, as shown in FIG. 1. Thus, the machine learning training algorithm 310 can train the machine learning model to capture the user behavior based on the role the user presents to the system along with the system log information. In some examples, the user role can be provided by the user device 106, or as part of the resource request 116.

As disclosed herein, the output of the risk assessment module 128 is the risk score 308, which will be used as an input to the response module 130, where it will receive the system information 306 and the user role 302 to generate, in some examples, threat alerts to a security operation center (SOC) team for their corrective action, for example, when a risk level is more than 2, otherwise it can be archived for future investigations.

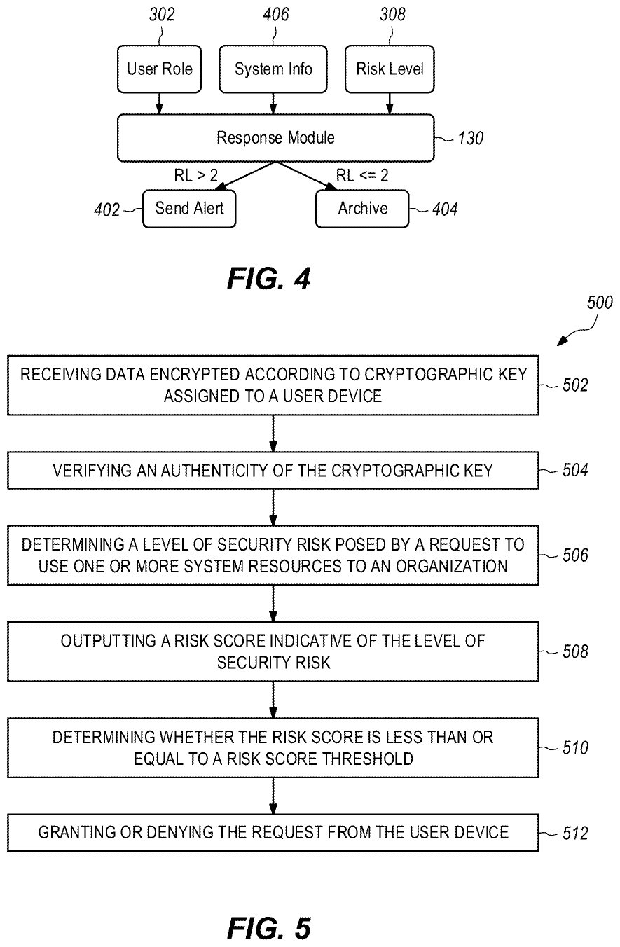

FIG. 4 is an example of the response module 130, as shown in FIGS. 1-2. Thus, reference can be made to one or more examples of FIGS. 1-3 in the example of FIG. 4. The response module 130 can receive the risk score 308, as shown in FIG. 3. The response module 130 can use the risk score 308 to determine a response level (RL) (or response action). The response module 130 can be programmed to identify a number of responses. In some examples, if the risk score 308 is high (e.g., exceeds a first risk score threshold), the response module 130 can take one type of response, whereas if the risk score 308 is medium (less than the first risk score threshold but greater than a second risk score threshold) the response module 130 can take another type of response. In some examples, if the risk score 308 is low (e.g., less than or equal to the second risk score threshold), the response module takes no action as the user risk level is low. By way of example, if the risk score 308 is high, the response module 130 can cause access to the data 118 to be blocked by issuing the response command 134. In some instances, if the risk score 308 is high or medium, the response module 130 can issue an alert. The alert can be provided to a SOC user, such as a device. The alert can be delivered as an email alert, a text message alert (e.g., as a short message service (SMS) alert), or an audible alert. By way of example, if the risk score 308 is more than 2 (shown as RL>2 in the example of FIG. 4), the alert can be generated at 402. If the risk score 308 is less than or equal to 2 (shown as RL<=2) the alert can be archived and thus stored in a database. The database could be implemented on the computing platform 108, as shown in FIG. 1. The user role (information) 302 and system information 406 can be stored in the database and associated with the alert stored in the database. In some examples, the user role 302 and system information 406 can be used as part of the alert that is provided to the SOC device. Thus, the alert can be generated based on the user role 302 and the system information 406. The system information 406 can include a server name. a server IP address, a file name, a location, a system owner, an operating system (OS) type, a source IP address, a destination IP address, an application name, an application ID, and/or running services.

In view of the foregoing structural and functional features described above, an example method will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 5 is an example of a method 500 for requesting use of one or more system resources. The method 500 can be implemented by the user risk analyzer 132, as shown in FIG. 1. Thus, reference can be made to one or more examples of FIGS. 1-4 in the example of FIG. 5. The method 500 can begin at 502 by receiving (e.g., by the user verification module 126, as shown in FIG. 1) data encrypted according to a cryptographic key (e.g., the user key 104, as shown in FIG. 1) from a user device (e.g., the user device 106, as shown in FIG. 1) requesting to use one or more system resources (e.g., accessing the data 118, as shown in FIG. 1). At 504, verifying an authenticity of the user key for the user device through a successful decryption of the encrypted data. At 506, determining (e.g., by the risk assessment module 128, as shown in FIG. 1) a level of security risk posed by the request from the user device (and thus a user of the user device) to an organization.

At 508, outputting (e.g., by the risk assessment module 128) a risk score (e.g., the risk score 308) indicative of the level of security risk posed by the request or the user device to the organization. At 510, determining (e.g., by the response module 130, as shown in FIG. 1) whether the risk score is less than or equal to a risk score threshold. At 512, granting (e.g., by the response module 130) the user device access to use the one or more system resources in response to the determining that the risk score is less than or equal to the risk score threshold, or denying the user device the request to use one or more system resources in response to determining that the risk score is greater than the risk score threshold. The use operating the user device from the request was issued and denied can be referred to as an insider threat.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

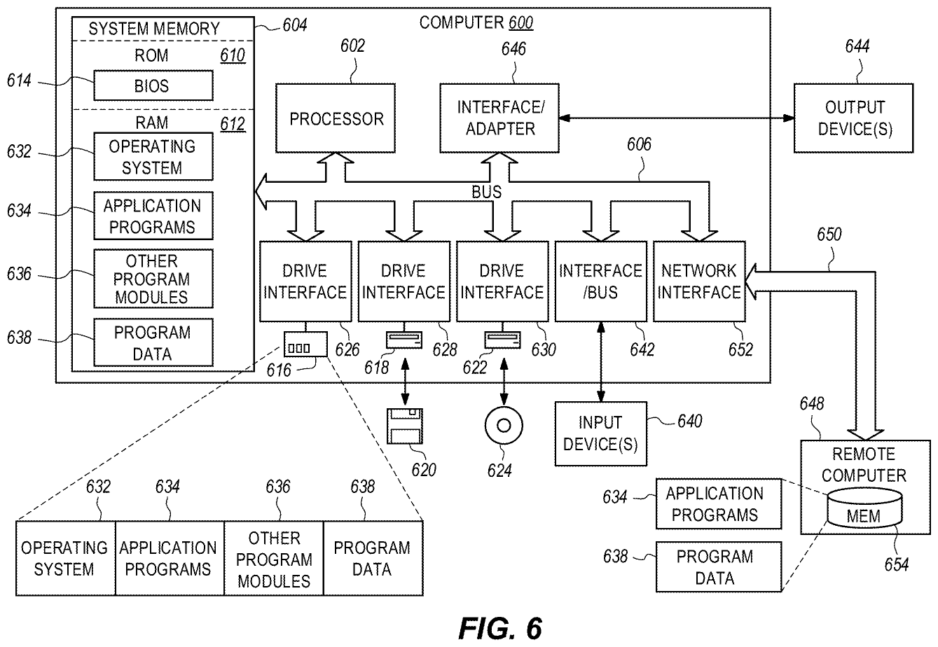

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Thus, reference can be made to one or more examples of FIGS. 1-5 in the example of FIG. 6.

In this regard, FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 612 containing the basic routines that help to transfer information among elements within computer system 600.

Computer system 600 can include a hard disk drive 616, magnetic disk drive 618, e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 610, including operating system 632, one or more application programs 634, other program modules 636, and program data 638. In some examples, the application programs 634 can include one or more modules (or block diagrams), or systems, as shown and disclosed herein. Thus, in some examples, the application programs 634 can include the user risk analyzer 132, as shown in FIG. 1.

A user may enter commands and information into computer system 600 through one or more input devices 640, such as a pointing device (e.g., a mouse, touch screen), keyboard, microphone, joystick, game pad, scanner, and the like. These and other input devices are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and a wide area network (WAN). When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

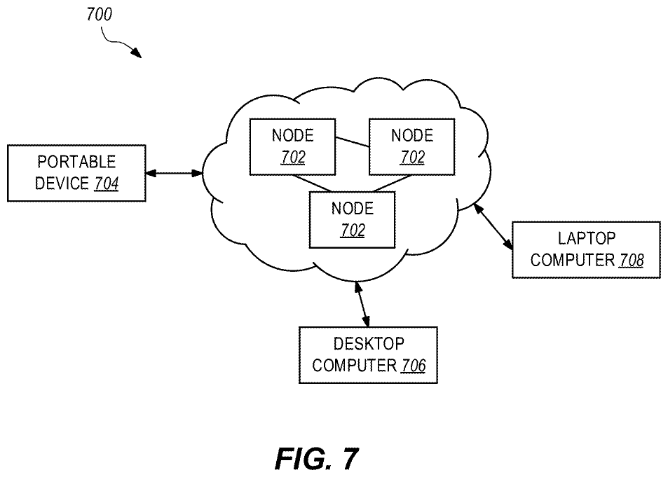

FIG. 7 is an example of a cloud computing environment 700 that can be used for implementing one or more modules and/or systems in accordance with one or more examples, as disclosed herein. Thus, reference can be made to one or more examples of FIGS. 1-6 in the example of FIG. 7. As shown, cloud computing environment 700 can include one or more cloud computing nodes 702 with which local computing devices used by cloud consumers (or users), such as, for example, personal digital assistant (PDA), cellular, or portable device 704, a desktop computer 706, and/or a laptop computer 708, may communicate. The computing nodes 702 can communicate with one another. In some examples, the computing nodes 702 can be grouped (not shown) physically or virtually, in one or more networks, such as Private, Community, Public, or Hybrid clouds, or a combination thereof. This allows the cloud computing environment 700 to offer infrastructure, platforms and/or software as services for which a cloud consumer does not need to maintain resources on a local computing device. The devices 704-708, as shown in FIG. 7, are intended to be illustrative and that computing nodes 702 and cloud computing environment 700 can communicate with any type of computerized device over any type of network and/or network addressable connection (e.g., using a web browser). In some examples, the one or more computing nodes 702 are used for implementing one or more examples disclosed herein relating to root-source identification. Thus, in some examples, the one or more computing nodes can be used to implement modules, platforms, and/or systems, as disclosed herein.

In some examples, the cloud computing environment 700 can provide one or more functional abstraction layers. It is to be understood that the cloud computing environment 700 need not provide all of the one or more functional abstraction layers (and corresponding functions and/or components), as disclosed herein. For example, the cloud computing environment 700 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 700 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 700 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 700, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 700 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 700 can provide a workloads layer that provides examples of functionality for which the cloud computing environment 700 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 700.

The present disclosure is also directed to the following exemplary embodiments, which can be practiced in any combination thereof:

Embodiments disclosed herein include: A. A computer implemented method comprising: receiving data encrypted according to a cryptographic key assigned to a user device requesting to use one or more system resources; verifying an authenticity of the cryptographic key for the user device corresponding to confirming an identity of the user device or a user of the user device; determining a level of security risk posed by the request from the user device to an organization in response to verifying the cryptographic key is authentic; outputting a risk score indicative of the level of security risk posed by the request to the organization; determining whether the risk score is less than or equal to a risk score threshold; one of: granting the user device access to use the one or more system resources in response to the determining that the risk score is less than or equal to the risk score threshold; and denying the user device the request to use one or more system resources in response to determining that the risk score is greater than the risk score threshold.

B. A system comprising a user device comprising a cryptographic key assigned for the user device, the user device being configured to encrypt data according to the cryptographic key, the data comprising a request to use one or more system resources; a server configured to: verify an authenticity of the cryptographic key for the user device corresponding to confirming an identity of the user device or a user of the user device; output, using a machine learning (ML) model, a risk score indicative of a level of security risk posed by a request from the user device to an organization in response to verifying the cryptographic key is authentic; determining whether the risk score is less than or equal to a risk score threshold; one of: causing the user device to be granted access to use the one or more system resources in response to the determining that the risk score is less than or equal to the risk score threshold; and causing the user device to deny the request to use one or more system resources in response to determining that the risk score is greater than the risk score threshold.

C. A system comprising: one or more computing platforms configured to: receive data encrypted according to a cryptographic key assigned to a user device requesting to use one or more system resources; verify an authenticity of the cryptographic key for the user device corresponding to confirming an identity of the user device or a user of the user device; determine a level of security risk posed by the request from the user device to an organization in response to verifying the cryptographic key is authentic; output a risk score indicative of the level of security risk posed by the request to the organization; determine whether the risk score is less than or equal to a risk score threshold; one of: grant the user device access to use the one or more system resources in response to the determining that the risk score is less than or equal to the risk score threshold; and deny the user device the request to use one or more system resources in response to determining that the risk score is greater than the risk score threshold.

Each of embodiments A through C may have one or more of the following additional elements in any combination: Element 1: comprising assigning the cryptographic key to the user device; Element 2: receiving a key request for the cryptographic key assigned to the user device; and providing the cryptographic key to the user device for use in confirming the identity of the user device or the user of the user device to a user risk analyzer executing on a computing platform; Element 3: wherein the cryptographic key is verified as authentic in response to a successful description of the encrypted data; Element 4: wherein the level of security of risk is determined based on a user role information for the user, user behavior information for the user, and system log information; Element 5: wherein a ML model is used to determine the level of security risk posed by the request from the user device to the organization and outputting a risk score indicative of the level of security risk posed by the request to the organization; Element 6: wherein the ML model is configured to determine the level of security risk posed by the request from the user device to the organization based on a user role information for the user, user behavior information for the user, and system log information; Element 7: wherein the user behavior information indicates how many access points has this specific user tried to enter, a number of successful and denied access requests, a time difference between requests, and a correlation with a user role of the user; Element 8: wherein the system log information characterizes a server name, server internet protocol (IP) address, files name, location, system owner, OS type, source IP address, destination IP address, application name, application ID, running services, and/or time; Element 9: wherein the user role information indicates an organizational role of the user; Element 10: wherein the server is configured to determine the risk score based on a user role information for the user, user behavior information for the user, and system log information; Element 11: wherein the user behavior information indicates how many access points has this specific user tried to enter, a number of successful and denied access requests, a time difference between requests, and a correlation with a user role of the user; Element 12: wherein the system log information characterizes a server name, server IP address, files name, location, system owner, OS type, source IP address, destination IP address, application name, application ID, running services, and/or time; Element 13: wherein the user role information indicates an organizational role of the user; Element 14: wherein the server is configured to generate an alert in response to causing the user device to deny the request to use one or more system resources; Element 15: wherein the alert is provided to another device using one of an email and a short message service (SMS) message; Element 16: wherein a ML model is used to determine the level of security risk posed by the request from the user device to the organization and outputting a risk score indicative of the level of security risk posed by the request to the organization based on a user role information for the user, user behavior information for the user, and system log information; and Element 20: wherein the one or more computing platforms is configured to generate an alert in response to causing the user device to deny the request to use one or more system resources.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A computer-implemented method comprising:
receiving data encrypted according to a cryptographic key assigned to a user device requesting to use one or more system resources;
verifying an authenticity of the cryptographic key for the user device corresponding to confirming an identity of the user device or a user of the user device;
determining a level of security risk posed by the request from the user device to an organization in response to verifying the cryptographic key is authentic;
outputting a risk score indicative of the level of security risk posed by the request to the organization;
determining whether the risk score is less than or equal to a risk score threshold;
one of:
granting the user device access to use the one or more system resources in response to the determining that the risk score is less than or equal to the risk score threshold; and
denying the user device the request to use one or more system resources in response to determining that the risk score is greater than the risk score threshold.

2. The computer-implemented method of claim 1, further comprising assigning the cryptographic key to the user device.

3. The computer-implemented method of claim 2, further comprising:
receiving a key request for the cryptographic key assigned to the user device; and
providing the cryptographic key to the user device for use in confirming the identity of the user device or the user of the user device to a user risk analyzer executing on a computing platform.

4. The computer-implemented method of claim 1, wherein the cryptographic key is verified as authentic in response to a successful description of the encrypted data.

5. The computer-implemented method of claim 1, wherein the level of security of risk is determined based on a user role information for the user, user behavior information for the user, and system log information.

6. The computer-implemented method of claim 1, wherein a machine learning (ML) model is used to determine the level of security risk posed by the request from the user device to the organization and outputting a risk score indicative of the level of security risk posed by the request to the organization.

7. The computer-implemented method of claim 6, wherein the ML model is configured to determine the level of security risk posed by the request from the user device to the organization based on a user role information for the user, user behavior information for the user, and system log information.

8. The computer-implemented method of claim 6, wherein the user behavior information indicates how many access points has this specific user tried to enter, a number of successful and denied access requests, a time difference between requests, and a correlation with a user role of the user.

9. The computer-implemented method of claim 6, wherein the system log information characterizes a server name, server internet protocol (IP) address, files name, location, system owner, operating system (OS) type, source IP address, destination IP address, application name, application identifier (ID), running services, and/or time.

10. The computer-implemented method of claim 6, wherein the user role information indicates an organizational role of the user.

11. A system comprising:
a user device comprising a cryptographic key assigned for the user device, the user device being configured to encrypt data according to the cryptographic key, the data comprising a request to use one or more system resources;
a server configured to:
verify an authenticity of the cryptographic key for the user device corresponding to confirming an identity of the user device or a user of the user device;
output, using a machine learning (ML) model, a risk score indicative of a level of security risk posed by a request from the user device to an organization in response to verifying the cryptographic key is authentic;
determining whether the risk score is less than or equal to a risk score threshold;
one of:
causing the user device to be granted access to use the one or more system resources in response to the determining that the risk score is less than or equal to the risk score threshold; and
causing the user device to deny the request to use one or more system resources in response to determining that the risk score is greater than the risk score threshold.

12. The system of claim 11, wherein the server is configured to determine the risk score based on a user role information for the user, user behavior information for the user, and system log information.

13. The system of claim 12, wherein the user behavior information indicates how many access points has this specific user tried to enter, a number of successful and denied access requests, a time difference between requests, and a correlation with a user role of the user.

14. The system of claim 12, wherein the system log information characterizes a server name, server internet protocol (IP) address, files name, location, system owner, operating system (OS) type, source IP address, destination IP address, application name, application identifier (ID), running services, and/or time.

15. The system of claim 12, wherein the user role information indicates an organizational role of the user.

16. The system of claim 10, wherein the server is configured to generate an alert in response to causing the user device to deny the request to use one or more system resources.

17. The system of claim 16, wherein the alert is provided to another device using one of an email and a short message service (SMS) message.

18. A system comprising:
one or more computing platforms configured to:
receive data encrypted according to a cryptographic key assigned to a user device requesting to use one or more system resources;
verify an authenticity of the cryptographic key for the user device corresponding to confirming an identity of the user device or a user of the user device;
determine a level of security risk posed by the request from the user device to an organization in response to verifying the cryptographic key is authentic;
output a risk score indicative of the level of security risk posed by the request to the organization;
determine whether the risk score is less than or equal to a risk score threshold;
one of:
grant the user device access to use the one or more system resources in response to the determining that the risk score is less than or equal to the risk score threshold; and
deny the user device the request to use one or more system resources in response to determining that the risk score is greater than the risk score threshold.

19. The system of claim 18, wherein a machine learning (ML) model is used to determine the level of security risk posed by the request from the user device to the organization and outputting a risk score indicative of the level of security risk posed by the request to the organization based on a user role information for the user, user behavior information for the user, and system log information.

20. The system of claim 19, wherein the one or more computing platforms is configured to generate an alert in response to causing the user device to deny the request to use one or more system resources.
